(19) United States
(12) Patent Application Publication
(10) Pub. No.: US 2007/0035229 A1
(43) Pub. Date: Feb. 15, 2007

(54) Light emitting display device

(76) Inventors: Yoshiro Mikami, Hitachiota (JP); Masakazu Sagawa, Inagi (JP); Tomoki Nakamura, Chiba (JP); Shoji Shirai, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/500,991

(22) Filed: Aug. 9, 2006

(30) Foreign Application Priority Data
Aug. 9, 2005 (JP) 2005-230504

(51) Int. Cl. H01J 63/04; H01J 1/62

(52) U.S. Cl. 313/495

(57) ABSTRACT

In a light emitting display device using electron emitter elements, it is possible to prevent lowering of image quality caused by spread of electron beams. MIM (Metal Insulator Metal) is used as the electron emitter elements and each of the electron emitter elements is surrounded by a conductive barrier (scanning wire). The electron emitter elements and the barriers are covered by upper electrodes so that the barriers and the surfaces of the electron emitter elements have the same electrical potential. The electron emitter elements and the barriers are formed on a cathode substrate. Color phosphors of R (red), G (green), and B (blue) are formed on an anode substrate at the side opposing to the cathode substrate. The color phosphors are excited by electron beams emitted from the electron emitter elements.

### INCORPORATION BY REFERENCE

The present application claims priority from Japanese application JP2005-230504 filed on Aug. 9, 2005, the content of which is hereby incorporated by reference into this application.

### BACKGROUND OF THE INVENTION

The present invention relates to a light emitting display device for converging electron beams emitted from a plurality of cold cathodes arranged in a matrix shape, causing the fluorescent surface to emit light, and displaying an image.

Various structures have been suggested for suppressing spread of an electron beam in the light emitting display device using a cold cathode as a planar electron source. For example, JP-A-2003-16924 discloses a field emission type electron source including a pixel structure having an insulative barrier on an electron source substrate for limiting spread of the electron beam emitted. Moreover, JP-A-2003-197132 discloses a cold cathode field electron emission display device including a spindt type electron source having a protrusion on the gate electrode for converging the electron orbit by the electron lens effect.

In the field emission type electron source disclosed in JP-A-2003-16924, a part of the electron beam emitted is blocked by the barrier and not comes onto the fluorescent surface. Accordingly, no color mixture is caused. However, the use efficiency of the electron beam is low, which in turn lowers the luminance and efficiency. Moreover, insulative (ceramic) barrier is charged by the irradiation of the electron beam, which causes discharge and lowers reliability.

Moreover, in the cold cathode field electron emission display device disclosed in JP-A-2003-197132, the method for providing a protrusion on the gate electrode has a high electron beam convergence effect and less lowering of the use efficiency of the electron beam. However, it is necessary to form/treat the gate electrode, which complicates a process, increases the cost, and lowers the throughput and yield.

### SUMMARY OF THE INVENTION

It is therefore an object of the present invention to provide a light emitting display device employing the electron beam convergence method having not lowering of image quality by color mixing, reducing the excitation loss of the electron beam, increasing the luminance and efficiency, and reducing the cost.

A light emitting display device includes a plurality of scanning wires intersecting a plurality of signal wires on a first substrate, electron emitter elements arranged at the intersections of the scanning wires and the signal wires, and phosphors arranged on a second substrate opposing to the first substrate and excited to emit light, by electron beams emitted from the electron emitter elements. Each of the electron emitter elements having MIM (Metal Insulator Metal) structure is surrounded by the scan wire, which serves as a barrier for the electron beam emitted from the electron emitter element. An electron lens is formed for each of the electron emitter elements by making the electrical potential of the scanning wires serving as barriers identical to the surface electrical potential of the electron emitter elements. By the function of this electron lens, the electron beam emitted from the electron emitter element is converged to excite the phosphors to emit light.

Moreover, both sides of the electron emitter element are sandwiched by the adjacent scanning wires and an electrical potential difference is set between the adjacent scanning wires and the electron emitter element, thereby forming an electron lens for each of the electron emitter elements.

According to the present invention, it is possible to obtain a preferable display quality having no color mixing. Since no electron beam spread exists, a highly accurate panel can be configured. Moreover, all the electron beam emitted hit the phosphor. That is, there is no electron beam excitation loss and it is possible to improve the efficiency and luminance.

Accordingly, the present invention may be employed to the FED (Field Emission Display) display device using MIM as the electron emitter element and an FED display device using other electron emitter elements such as the SED (Surface Electron emission Display).

Other objects, features and advantages of the invention will become apparent from the following description of the embodiments of the invention taken in conjunction with the accompanying drawings.

### BRIEF DESCRIPTION OF THE DRAWINGS

FIG. 1 is a partial cross sectional view of pixels in a light emitting display device according to an embodiment of the present invention.

FIG. 2 is a conceptual diagram showing equipotential plane corresponding to a part of FIG. 1 enlarged.

FIG. 3 shows relationship between the intensity of the lateral direction deflection field and the convergence of the electron beam according to an embodiment of the present invention.

FIG. 4 shows a planar structure of a pixel according to an embodiment of the present invention.

FIG. 5 shows a cross-sectional structure of a pixel according to an embodiment of the present invention.

FIG. 6A shows a horizontal cross sectional structure of a pixel according to an embodiment of the present invention.

FIG. 6B shows a vertical cross sectional structure of a pixel according to an embodiment of the present invention.

FIG. 7A shows a pixel configuration employing an SED (surface conduction type thin film electron emitter element) according to an embodiment of the present invention.

FIG. 7B shows conceptual view of a pixel circuit employing the SED (surface conduction type thin film electron emitter element) according to an embodiment of the present invention.

FIG. 8A shows a planar structure of a pixel according to an embodiment of the present invention.

FIG. 8B shows a drive voltage waveform of the scanning wire according to an embodiment of the present invention.

FIG. 9 is a cross sectional view about the dotted broken line A-B in FIG. 8.

FIG. 10 shows a drive voltage waveform of the scanning wire according to an embodiment of the present invention.

FIG. 11 shows another drive voltage waveform of the scanning wire according to an embodiment of the present invention.

### DETAILED DESCRIPTION OF EMBODIMENTS

Description will now be directed to embodiments of the present invention with reference to the attached drawings.

### Embodiment 1

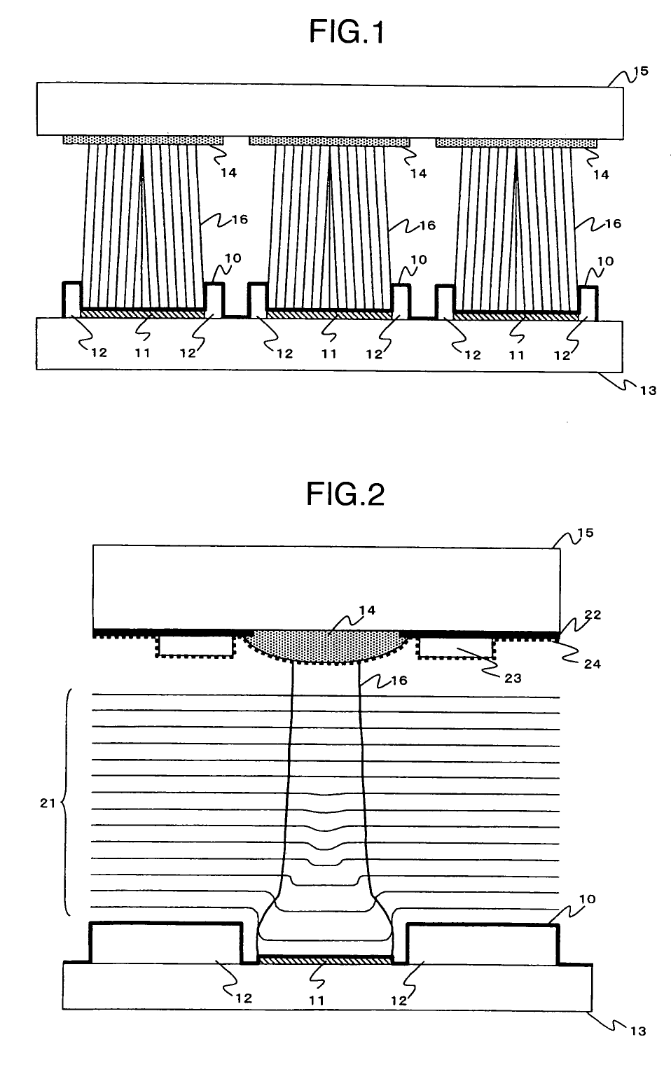

FIG. 1 is a partial cross sectional view of pixels in a light emitting display device according to an embodiment of the present invention. MIM is used as an electron emitter element 11 which is surrounded by a conductive barrier 12 (scanning wire).

The electron emitter element 11 is surrounded by a barrier 12 of the same potential as the cathode potential. At least a surface of the barrier 12 is formed by a conductive layer so that the surface potential of the barrier 12 and the electron emitter element 11 are identical. That is, the electron emitter element 11 and the barrier 12 are covered by an upper electrode 10.

The electron emitter element 11 and the barrier 12 are formed on a cathode substrate 13. An anode substrate 15 having R (red), G (green), and B (blue) color phosphor 14 opposes to the cathode substrate 13. The color phosphors 14 are excited to emit colors by the electron beam 16 emitted from the electron emitter element 11.

FIG. 2 is a conceptual diagram showing an equipotential plane, i.e., a part of FIG. 1 enlarged. Equipotential lines 21 and trace of electron beam 16 are shown.

In FIG. 2, in side the anode substrate 15 a black color layer (black matrix) 22 and an anode barrier 23 are formed so as to surround the phosphor 14. A metal back 24 is formed to cover the phosphor 14, the black color layer 22, and the anode barrier 23 and anode voltage is applied. It should be noted that the black color layer has an opening width greater than the opening width (vertical and horizontal width) of the electron emitter element.

The equipotential line 21 generated between a positive high voltage applied through this metal back 24 and a drive voltage of several volts applied to the electron emitter element 11 and the barrier 12 on the cathode substrate 13 generate a convex distorted distribution where the distribution of the equipotential line 21 is changed by the affect of a component parallel to the substrate and the barrier 12 in the vicinity of the barrier 12.

By this distribution, the electron beam 16 emitted from the electron emitter element 11 in all the directions changes its electron orbit by the affect of the electric field distorted in the direction of the center of the electron beam 16 when passing through the distorted region of the equipotential line 21. The electron beam 16 is converged and emitted onto the phosphors 14 on the anode substrate 15. Accordingly, only the phosphor 14 corresponding to the electron emitter element 11 as a pixel is excited.

Consequently, the electron beam spot is not increased and an adjacent phosphor is not excited. That is, no color mixing is caused and preferable image quality can be obtained. Moreover, since all the electron beams excite the phosphors, use efficiency of the electron beams is excellent. It is possible to reduce the power consumption regardless of the fine display.

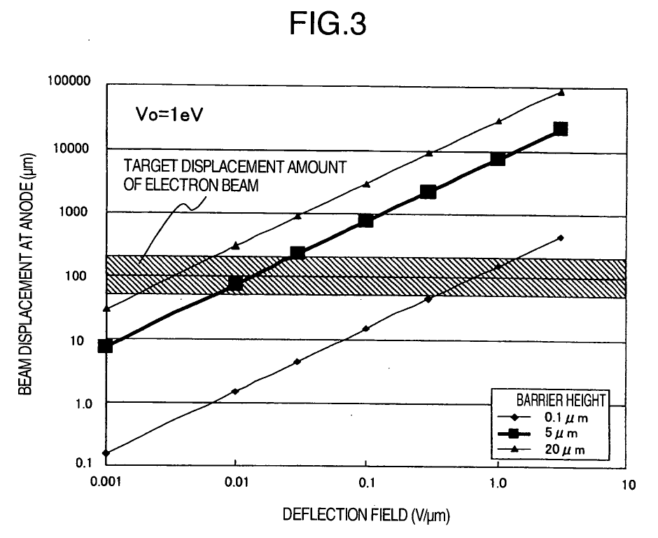

FIG. 3 shows a calculation result about the relationship between the intensity of the horizontal deflection field as a distorted component of the electric field and the convergence of the electron beam. This is the case when the distance between the cathode substrate 13 and the anode substrate 15 is 3 mm, the energy when emitting the electron beam is 1 eV, and the height of the barrier 12 surrounding the electron emitter element 11 is 0.1 μm, 5 μm, and 20 μm. It can be known that correction can be performed if the field for obtaining an electron beam orbit displacement amount 50-200 μm for each case is 0.002 V/μm to 2 V/μm. Actually, the beam displacement amount is changed by the distance between height of the barrier 12 and the electron emitter element 11. However, it has been known that correction can be performed when the partition 12 has a height 0.1 to 20 μm.

As a member forming the barrier 12, a thin film wire is used. Since the scanning wire should have low resistance because the electron emitter element 11 is a current drive type and is based on the line successive drive method, it employs a thicker film than the signal wire and is appropriate for forming the barrier 12 having a high convergence effect. Thus, when the barrier 12 is formed by scanning wire, the scanning wire (barrier 12) and the electron emitter element 11 are covered by the upper electrode 10 and have the same potential. Accordingly, the potential of the scanning wire is automatically becomes identical to the surface potential of the electron emitter element 11. Thus, it is possible to easily configure the barrier 12 without adding a new process to the conventional process.

Alternatively, the barrier 12 can also be formed by the following methods. (1) The barrier 12 is arranged by using a spacer bonding conductive flit around the electron emitter element 11. The electron emitter element 11 is arranged in the groove of the san wire so that the film thickness of the scanning wire and the flit film thickness become the height of the barrier, thereby obtaining a high convergence effect. (2) A metal layer is added around the electron emitter element 11 and photolithography is added to form the barrier 12. (3) A protection resistance pattern having an opening only around the electron emitter element 11 is formed and the barrier 12 is selectively formed by metal plating. (4) A form of the barrier 12 is formed by an insulating layer around the electron emitter element 11 and it is coated by an electrode, so that the barrier 12 becomes conductive.

Moreover, as the MIM insulating film of the electron emitter element 11, an insulating film such as an AO (Anode Oxide) film, SiO, SiN of 100 to 300 nm is used. It is possible to form the barrier 12 by using these layers. The electron emitter element employed may be other than MIM such as the SED (surface-conduction electron-emitter display), the spindt type electron emitter element, a field emitting element using CNT (Carbon Nano Tube), and the electron emitter element using polysilicon and quantum tunnel effect. It is possible any device if it is a planar electron source having a plenty of solid electron emitter elements formed on a plane.

### Embodiment 2

This embodiment shows a specific pixel structure for easily realizing the Embodiment 1. In addition to this, this embodiment has a structure for increasing the electron beam displacement and reducing the affect of spacer bonding member required for the display panel structure to the electron beam displacement. Moreover, this embodiment does not irradiate a phosphor of an adjacent pixel even there is a minute amount of electron beam which has not been converged.

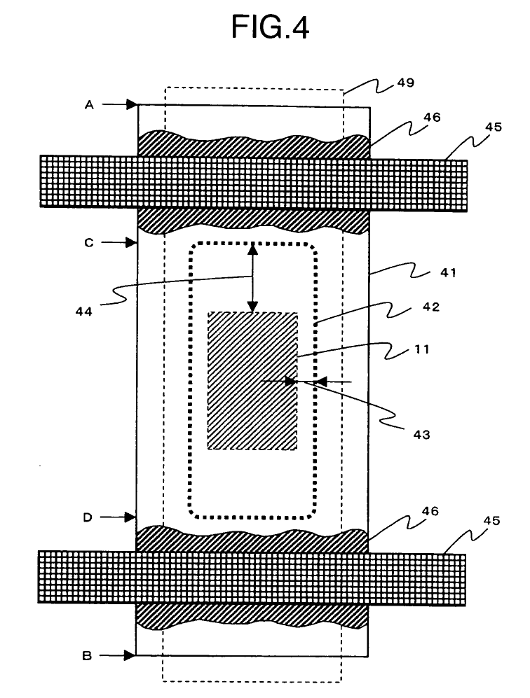

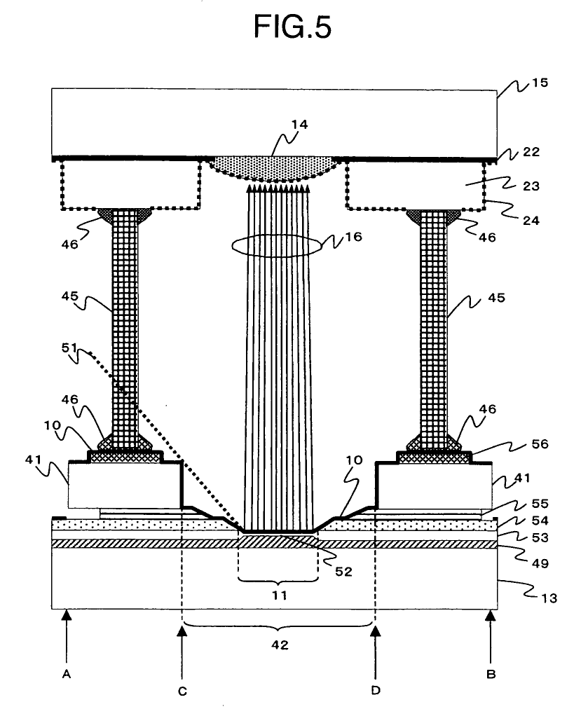

FIG. 4 shows a planar structure of a pixel. FIG. 5 shows a cross sectional view of a pixel in which the positions shown by arrows A, B, C, D correspond to the positions A, B, C, D in FIG. 4. The electron emitter element 11 is provided in the groove 42 of the scanning wire 41, i.e., the groove 42 of the upper electrode 10 of the scanning wire 41. The electron emitter element 11 is selected by the scanning wire 41 and the signal wire 49 and emits an electron beam 16.

In FIG. 4, the distance from the periphery of the electron emitter element 11 to the scanning wire groove 42 is different between in the horizontal direction and in the vertical direction. The horizontal direction 43 is smaller than the vertical direction 44. This is because the color display panel has longitudinal stripe structure and pixels are successively arranged in RGBRGB from left to right. The pixel shape is such that the horizontal width is only ⅓ of the vertical length and the allowance width of the color mixing by spread of the electron beam is stricter in the horizontal direction than the vertical direction by 3 times and it is necessary to converge the electron beam more strongly in the horizontal direction.

Accordingly, in this embodiment, the distance between the barrier formed by the scanning wire 41 and the electron emitter element 11 is narrowed in the horizontal direction than the vertical direction, thereby intensifying the convergence effect in the horizontal direction. Moreover, in order to improve the convergence, the potential distribution should be varied between the vertical direction and the horizontal direction instead of uniform potential distribution in the electron beam cross section, thereby enhancing the convergence effect of the electron beam.

Moreover, in order to realize a display panel holding a space between the cathode substrate and the anode substrate and holding a vacuum state inside the display panel in the atmosphere, a spacer 45 should be arranged on the display panel. However, a spacer bonding member 46 such as flit glass is used for fixing the spacer 45 to the cathode substrate and the anode substrate. An electron beam is emitted in the same direction from the surface of the electron emitter element 11 and part of the beam hits the spacer bonding member 46. The surface of the spacer bonding member 46 is charged, which changes the orbit of the electron beam. The same phenomenon also occurs at the bottom of the spacer 45 near to the cathode substrate. That is, the spacer 45 has low conductivity and is easily charged because it should have the function to insulate the anode substrate and the cathode substrate. Thus, the local charge at the bottom of the spacer 45 or at the spacer bonding member 46 causes a discharge in the tube, which significantly lowers the display panel reliability.

In order to solve this problem, as shown in FIG. 5, the spacer bonding member 46 is arranged apart from the scanning wire groove 42 and outside a visibility line 51 from the outer end of the electron emitter element 11 to the border end of the scanning wire groove 42, so as to prevent reach of the electron beam 16 to spacer bonding member 46 and prevent displacement effect of the electron beam 16 by charging of the spacer bonding member 46, thereby preventing the change of luminance in the vicinity of the spacer 45. Because of the same reason, it is preferable that the bottom of the spacer 45 be set higher than the scanning wire 41.

Furthermore, on the anode substrate 15, a phosphor 14 arranged at the opening portion of the black color layer 22 is surrounded by an anode barrier 23 having an opening greater than the opening of the black color layer 22. Moreover, in order to effectively take the light emission of the phosphor 14 forward so as to increase the luminance, a metal back 24 is provided. It should be noted that on the Al signal wire 49, an inter-layer insulation film 53 formed by an AO film forming a MIM insulation layer 52, a SiN film 54, and a Cr film 55 are successively formed while on the Cr film 55, the Al scan film 41 and the Cr film 56 are successively formed.

In the cathode structure of the present embodiment, the electron beam convergence effect is higher around the electron beam and the field distortion is small at the center portion of the electron beam. Accordingly, the convergence effect is low at the center of the electron beam in the vicinity of the electron emitter element 11 and the electron beam of this portion is spread in the vicinity of the anode substrate 15. For this, the shape of the electron beam irradiating the phosphor 14 is substantially equal to the size of the electron emitter element 11. However, the electron beam bottom is slightly spread at the periphery of the phosphor 14 to cause multiple reflection and the like, which in turn cause slight light emission on the phosphor of the adjacent pixel. Moreover, when the beam is applied to the anode substrate 15 and the spacer bonding member 46 of the spacer 45, these portions are charged to cause the deflection of the electron beam and discharge in the tube.

The electron beam formation is unique to the cathode structure according to the present embodiment and is a new problem. To cope with this, an anode barrier 23 is arranged to prevent slight light emission of a pixel by the electron from the adjacent pixels in the periphery, which in turn prevents slight color mixing and enables display of high color accuracy. Simultaneously with this, the barrier 25 can prevent deflection of the beam and discharge in the tube.

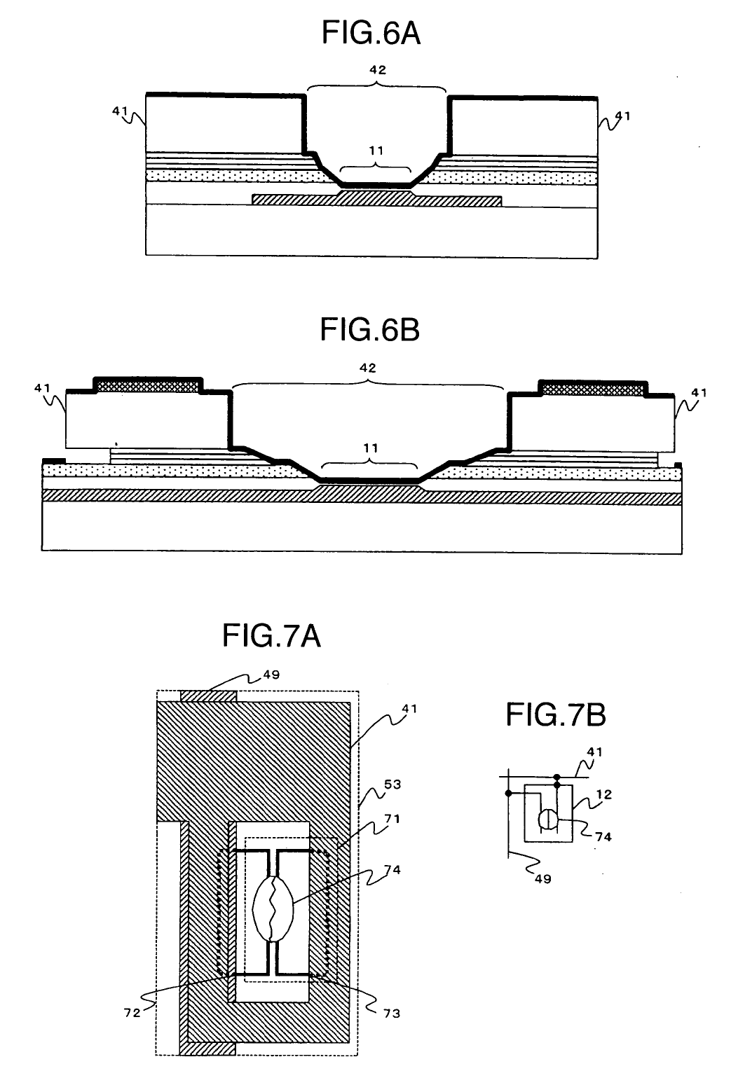

FIG. 6A and FIG. 6B show cross sectional structures of a pixel. FIG. 6A is a horizontal cross sectional view of FIG. 4 and FIG. 6B is a vertical cross sectional view of FIG. 4. The electron emitter element 11 is surrounded by a barrier of the scanning wire 41. The electron emitter element 11 is arranged at the center portion of the scanning wire groove 42. The other configurations are identical to those of FIG. 5.

### Embodiment 3

FIG. 7A shows a pixel configuration employing the SED (surface-conduction electron-emitting display) and FIG. 7B is a conceptual diagram of the pixel circuit. As shown in FIG. 7A, two platinum display electrodes 72, 73 connected to the scanning wire 41 and the signal line 49 are exposed to an opening 71 of the inter-layer insulation film 53 and a PbO pattern is formed between the display electrodes.

The SED element 74 is surrounded by the opening 75 of the scanning wire 41. As shown in FIG. 7B, the SED element 74 is surrounded by the barrier 12 connected to the scanning wire 41, thereby forming an electron lens using the scanning wire 41 as the barrier 12. It should be noted that the opening 75 may be arranged at the signal wire. In this case, the barrier 12 has a potential different from that of the scanning wire 41. Accordingly, it is possible to obtain a greater electron beam convergence effect.

### Embodiment 4

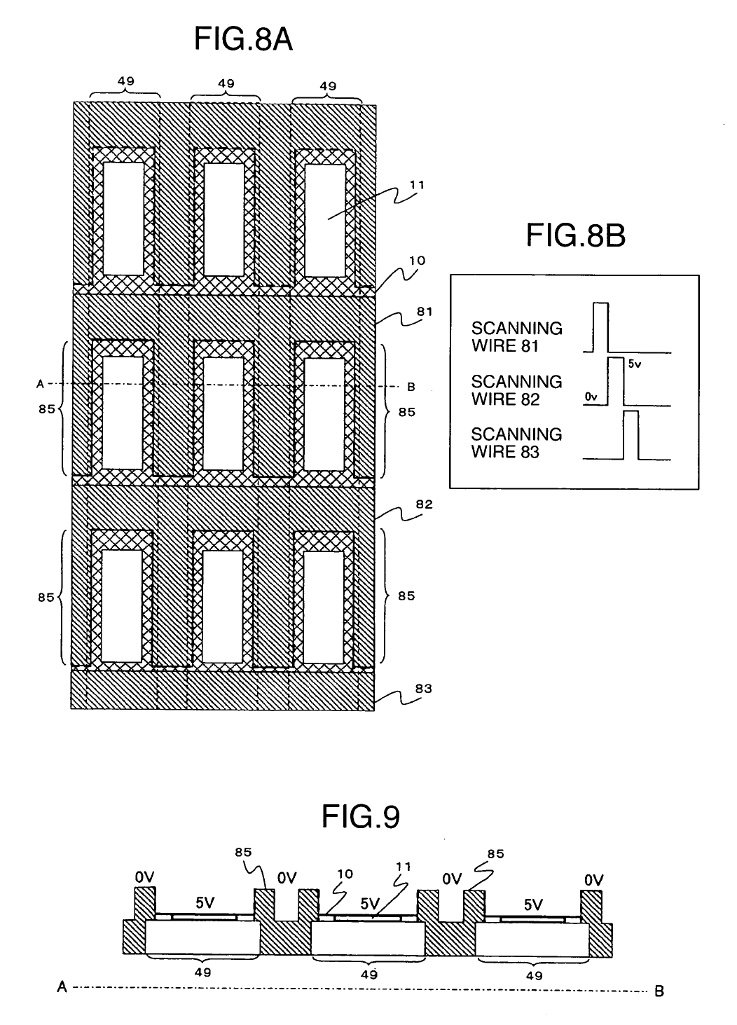

FIG. 8A is a plan view of a pixel and FIG. 8B shows a scanning wire drive voltage waveform. FIG. 9 is a cross sectional view about the dotted broken line A-B shown in FIG. 8A. This embodiment is characterized in that voltage is applied to the scanning wire adjacent to the pixel so as to apply a differential voltage for displacing the electron beam to the pixel surface and the scanning wire, thereby improving the beam convergence effect.

In FIG. 8A, each of the scanning wires 81, 82, 83 is formed in a comb shape having an electron beam spread suppression electrode 85, so that the electron emitter element 11 is sandwiched by the suppression electrodes 85. It should be noted that the surface of the electron emitter element 11 formed on the signal wire 49 is connected to the scanning wire of the lower side in the figure by using the upper electrode 10. Moreover, the suppression electrodes 85 shown by dotted lines in the figure and each comb edge of the scanning wire have reverse-tapered step so as to be isolated by step-cutting of the upper electrode 10. It is also possible to separate the respective scanning wires by patterning the upper electrode 10 by using lift-off, etching. FIG. 8B shows a drive voltage waveform to be applied to each of the scanning wires 81, 82, and 83.

In FIG. 9, voltage of the scanning wire selected is applied via the upper electrode 10 to the surface of the electron emitter element 11 on the signal wire 49. At the left and at the right of the electron emitter element 11, adjacent scanning wire patterns extend in comb shapes, where the electron beam spread suppression electrodes 85 are arranged.

As for the scanning wire drive voltage, a waveform of line successive scan is applied as shown in FIG. 8B. During a period when the #n+1-th scanning wire shown by the scanning wire 82 is selected, 5V is applied as the scanning wire voltage, and 0V is applied to the #n-th and #n+2-th scanning wires shown by the other scanning wires 81 and 83. Thus, synchronized with the scan pulse, a spread suppression electrode drive period is provided as a period when the adjacent scan line drive voltage is applied to the spread suppression electrode 85.

Here, as shown in FIG. 9, the surface of the #n+1-th electron emitter element 11 shown by the scanning wire 82 becomes 5V while the beam spread suppression electrode 85 becomes 0V. For this, the electron beam emitted from the electron emitter element 11 is subjected to a correction field formed by the potential difference between the potential of the beam spread suppression electrode 85 and the surface of the electron emitter element 11 so that the electron beam is converged in the width direction and advances in the anode substrate direction.

It should be noted that the beam spread suppression electrode 85 is preferably connected to a scanning wire other than the one surrounded by itself. However, by connecting it to the scanning wire preceding itself in the scan direction, it is possible to obtain an advantage that no potential fluctuation is caused because it is after the scan pulse application.

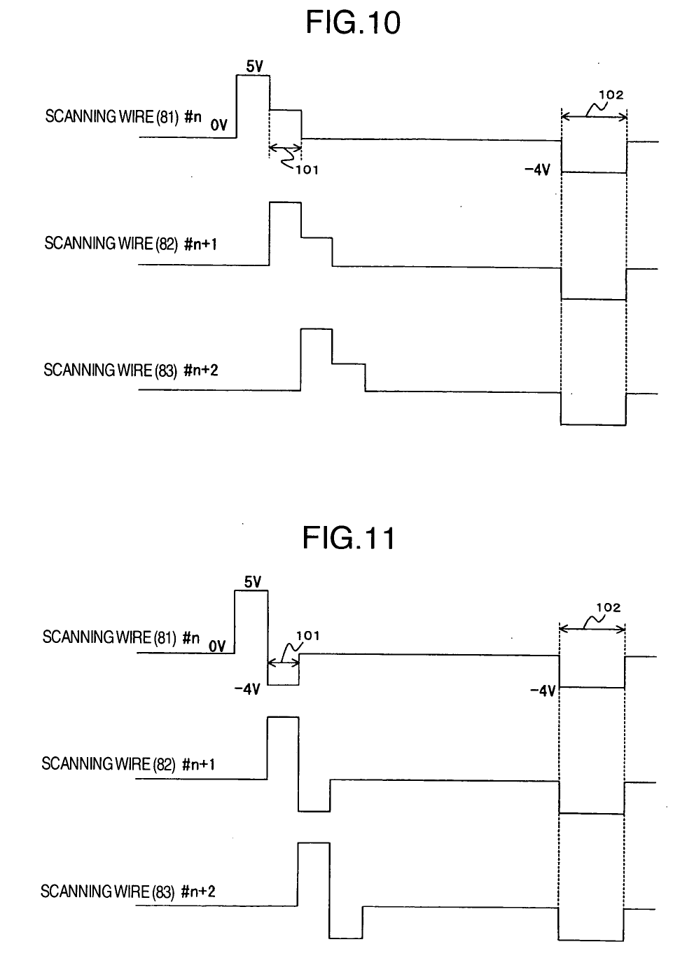

Moreover, as shown in FIG. 10, it is possible to adjust the voltage of the electron beam spread suppression electrode 85 by providing an electron beam spread suppression electrode drive period 101 after the scan pulse (5V) and applying a voltage lower than the potential of the scan pulse. Thus, it is possible to apply an arbitrary voltage so as to obtain an optimal electron beam spread and arbitrarily adjust the electron beam spread on the anode substrate. Accordingly, the electron beam can be sufficiently applied to the phosphor of an arbitrary area on the anode substrate without leaving an unnecessary portion. That is, it is possible to apply the electron beam effectively to the entire surface of the phosphor, thereby improving the service life of the phosphor and reliability.

It should be noted that when the electron beam spread suppression electrode 85 is connected to a scanning wire following the scanning wire of the pixel surrounded by itself, it is possible to adjust the voltage of the beam spread suppression electrode by applying a voltage lower than the scan voltage before the scan period.

Furthermore, as shown in FIG. 11, by setting the potential of the electron beam spread suppression electrode drive period 101 so that application voltage of the electron emitter element is negative (−4V), it is possible to apply a reverse pulse advantageous for improvement of the service life of the electron emitter element immediately before or immediately after the light emission. This improves the reliability of the electron emitter element and prolongs its service life. Furthermore, by applying the reverse pulse even during a fly-back period 102, the total application time of the reverse pulse is increased, which further increases the service life and improves the reliability.

Moreover, when a scanning wire apart by several wires is connected to the electron beam spread suppression electrode, it is possible to connect a stable voltage temporally apart from the scan pulse to the suppression electrode, which enables a beam width correction without fluctuations. In this case, by using a signal wire layer or an additional wire layer, the scanning wire is connected to the suppression electrode with an intersection structure over a pixel.

It should be further understood by those skilled in the art that although the foregoing description has been made on embodiments of the invention, the invention is not limited thereto and various changes and modifications may be made without departing from the spirit of the invention and the scope of the appended claims.

1. A light emitting display device comprising a plurality of scanning wires intersecting a plurality of signal wires on a first substrate, electron emitter elements arranged at intersections of the scanning wires and the signal wires, and phosphors arranged on a second substrate opposing to the first substrate and excited to emit light, by electron beams emitted from the electron emitter elements,
wherein an electron lens is arranged for each of the electron emitter elements to make the scanning wires serving as barriers to surround the electron emitter elements have same electrical potential as surfaces of the electron emitter element.

2. The light emitting display device as claimed in claim 1, wherein the electron emitter elements are arranged in grooves of the scanning wires and other portions of the scanning wires than the grooves serve as barriers.

3. The light emitting display device as claimed in claim 1, wherein upper electrodes are arranged on the scan wires and the electron emitter element surfaces and rear surfaces of the electron emitter elements are arranged on the signal wires.

4. The light emitting display device as claimed in claim 1, wherein a horizontal distance between the scan wires and the electron emitter elements serving as barriers is narrower than a vertical distance between the scan wires and the electron emitter elements serving as barriers.

5. The light emitting display device as claimed in claim 1, wherein spacers are arranged on the scanning wires serving as barriers to prevent reach of electron beams to spacer bonding members bonding the spacers.

6. The light emitting display device as claimed in claim 1, wherein a black color layer is arranged around the phosphor and the black color layer has an opening width greater than an opening width of the electron emitter elements.

7. A light emitting display device comprising a plurality of scanning wires intersecting a plurality of signal wires on a first substrate, electron emitter elements arranged at the intersections of the scanning wires and the signal wires, and a phosphor arranged on a second substrate opposing to the first substrate and excited to emit light, by electron beams emitted from the electron emitter elements,
wherein an electron lens is arranged for each of the electron emitter elements by an electrical potential difference between adjacent scanning wires serving as barriers to sandwich both sides of the electron emitter elements and surfaces of the electron emitter elements.
